(19) United States
(12) Patent Application Publication
(10) Pub. No.: US 2011/0216894 A1
(43) Pub. Date: Sep. 8, 2011

(54) Tool for Assessing Early Termination Penalty

(75) Inventor: Richard S. Lipman, Iowa City, IA (US)

(73) Assignee: PAETEC COMMUNICATIONS, INC., Fairport, NY (US)

(21) Appl. No.: 12/759,940

(22) Filed: Apr. 14, 2010

Related U.S. Application Data
(60) Provisional application No. 61/310,980, filed on Mar. 5, 2010.

(51) Int. Cl. H04M 15/00

(52) U.S. Cl. 379/114.03

(57) ABSTRACT

A computer-implemented method and tool for assessing an early termination penalty on telecommunications service subscribers. In response to a subscriber's request for termination, a customer service representative engages the computerized assessment tool to answer a series of questions about that subscriber. The tool assigns a predetermined weight to each answer and calculates a final score when all questions have been answered. Based on this final score, the tool determines whether an early termination penalty should be levied and provides notice to the customer service representative.

### RELATED APPLICATIONS

This application claims priority to U.S. Provisional Patent Application Ser. No. 61/310,980 filed Mar. 5, 2010, which is hereby incorporated by reference in its entirety.

### BACKGROUND OF THE INVENTION

1. Field of the Invention

The present invention relates to a computer program, and, more specifically, to a computer-implemented method and system for assessing an early termination penalty.

2. Description of the Related Art

Telecommunication capabilities are a vital component of any modern business. These capabilities, including data, voice, and Internet services, allow a business to effectively compete in a global market. Many businesses and individuals contract with telecommunications providers who provide the business or individual with these capabilities. These service plans typically require the subscriber to commit to a certain length of service, such as one, three or five years. This length of service provides several benefits to the telecommunications provider, including subsidizing the service provider's expenses for installation, purchase of expensive telecommunications devices, and systems upgrades, and also allows the provider to grant a lower rate.

Early termination of the telecommunications service plan will sometimes result in a penalty levied by the telecommunications provider to the user. The telecommunications provider's determination of whether to impose an early termination penalty depends on a multitude of factors, including the subscriber's reasons for terminating, their experience with the telecommunications provider over the course of the subscription, any problems the subscriber might have experienced either as a result of its own actions or the provider's actions, and how much time remains in the original service plan, among many others. As a direct result of this multitude of factors, the penalty determination is often a subjective and time-consuming decision. Additionally, if this decision is made in an unsystematic and inconsistent way across the provider's organization, it can lead to negative results.

In view of the foregoing considerations, there is a need for a tool and method that provides a more objective and consistent-across-the-provider's-organization mechanism for determining whether to impose an early termination penalty. There is also a need for a more efficient method for determining whether to impose an early termination penalty.

### BRIEF SUMMARY OF THE INVENTION

It is therefore a principal object and advantage of the present invention to provide a computer-implemented method and system for assessing an early termination penalty.

It is another object and advantage of the present invention to provide a tool and method for systematically and objectively assessing an early termination penalty.

It is yet another object and advantage of the present invention to provide a method and system for assessing whether to impose an early termination penalty in a time-efficient manner.

Other objects and advantages of the present invention will in part be obvious, and in part appear hereinafter.

In accordance with the foregoing objects and advantages, the present invention provides a method for recommending whether a telecommunications provider should levy an early termination penalty on a telecommunications service subscriber upon termination of the subscriber's service plan. The method comprises: (i) receiving a request to terminate the subscriber's service plan; (ii) providing a question about the subscriber; (iii) receiving an answer to the question about the subscriber; (iv) assigning a score to the answer; (v) storing the answer and score in a memory device; (vi) calculating a final score based on the stored scores; and (vii) determining whether to levy an early termination penalty on the subscriber based on the final score.

A second aspect of the invention provides a method for recommending whether a telecommunications provider should levy an early termination penalty on a telecommunications service subscriber upon termination of the subscriber's service plan, where each of the answers to the questions about the subscriber are assigned a predetermined score.

A third aspect of the invention provides a method for recommending whether a telecommunications provider should levy an early termination penalty on a telecommunications service subscriber upon termination of the subscriber's service plan, where the method is performed automatically by a computer program whenever a request to terminate a subscriber's service plan is received by the service provider. The automated method can be completed using account information stored by the service provider.

A fourth aspect of the invention provides a method for recommending whether a telecommunications provider should levy an early termination penalty on a telecommunications service subscriber upon termination of the subscriber's service plan, where a customer service representative is notified of the tool's final assessment whether to levy an early termination penalty.

A fifth aspect of the invention provides an early termination penalty assessment tool. The tool comprises: (i) a memory storage device that stores questions and possible answers to each question; (ii) a user interface that displays the questions and possible answers to a user and receives input from the user selecting one of the possible answers; and (iii) a processor that assigns a score to each of the selected answers, calculates a final score based on the assigned scores, and then uses the final score to determine whether to assess an early termination penalty. In other embodiments, the early termination penalty assessment tool comprises a customer information database.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a high-level flow diagram illustrating one embodiment of the invention;

FIG. 2 is a software schematic of the system according to one embodiment of the invention;

FIG. 3 is a representative screenshot of the assessment tool according to one embodiment of the invention;

FIG. 4 is a representative screenshot of a portion of the assessment tool showing the pull-down menus;

FIG. 5 is a representative screenshot of the assessment tool; and

FIGS. 6A-6C are representative screenshots of the assessment tool's calculation results, including a positive result to assess an early termination penalty in FIG. 6A, an unclear result requiring further analysis in FIG. 6B, and a negative result indicating the user not to assess an early termination penalty in FIG. 6C.

### DETAILED DESCRIPTION OF THE INVENTION

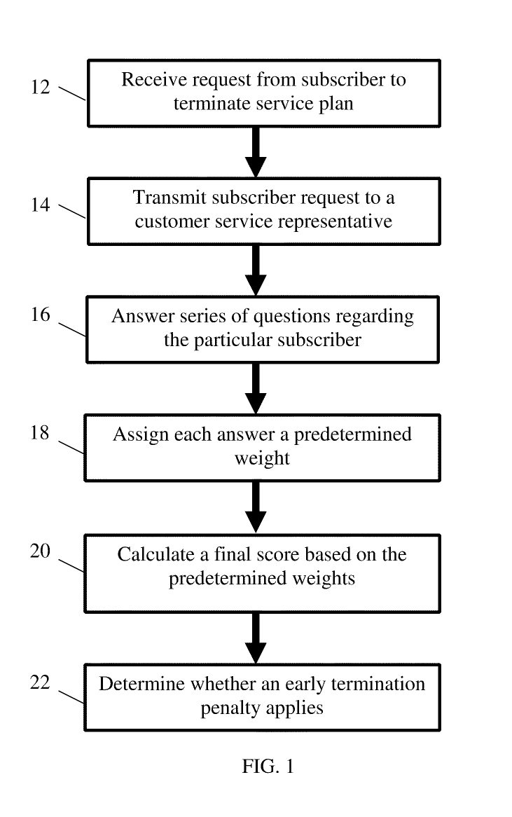

Referring now to the drawings, wherein like reference numerals refer to like parts throughout, there is seen in FIG. 1 a high-level flow diagram illustrating a preferred embodiment of the invention. As an initial step 12, the telecommunications provider receives a request or demand from a subscriber to terminate the subscriber's service plan. The service plan can be for voice, data, and/or Internet services, or for any other service offered by the service provider. The termination request can be prompted by any motive, including the termination of a business, a change in business needs, problems caused by the subscriber, or problems caused by the provider, among many other reasons. The request for termination must, however, involve a service plan that has not already expired or previously been terminated, as an early termination penalty will not usually apply in those situations. In step 14, the subscriber's request is transmitted to a customer service representative or other evaluator for further evaluation via the assessment tool.

In step 16, the customer service representative engages the early termination penalty assessment computer program 10 to determine whether to levy a penalty on the particular subscriber. To complete the assessment, the representative activates, opens, or otherwise initiates computer program 10 and responds to a series of question prompts through a user interface. These questions can include, among many other types of questions, the following: (i) is the subscriber going out of business?; (ii) will the subscriber engage another carrier after termination?; (iii) did the subscriber experience service problems over the course of the service plan?; (iv) did the subscriber open trouble tickets or request troubleshooting assistance over the course of the service plan?; (v) has the service plan provider granted credits to the subscriber in response to service issues experienced by the subscriber?; (vi) is the service plan still within the original term?; (vii) has the original term of the service plan expired, but the plan was renewed by the subscriber?; (viii) has the original term of the service plan and any additional renewal(s) expired and the service plan in place only due to an auto-renewal clause?; (ix) has the subscriber objected to an early termination penalty?; (x) has the subscriber engaged an attorney to contest an early termination penalty?; and (xi) if the service plan is for circuits, are the circuits mainly off-net or on-net? In a preferred embodiment, the assessment program prompts the user to enter information pertinent to the question of whether to levy a early termination penalty on the subscriber.

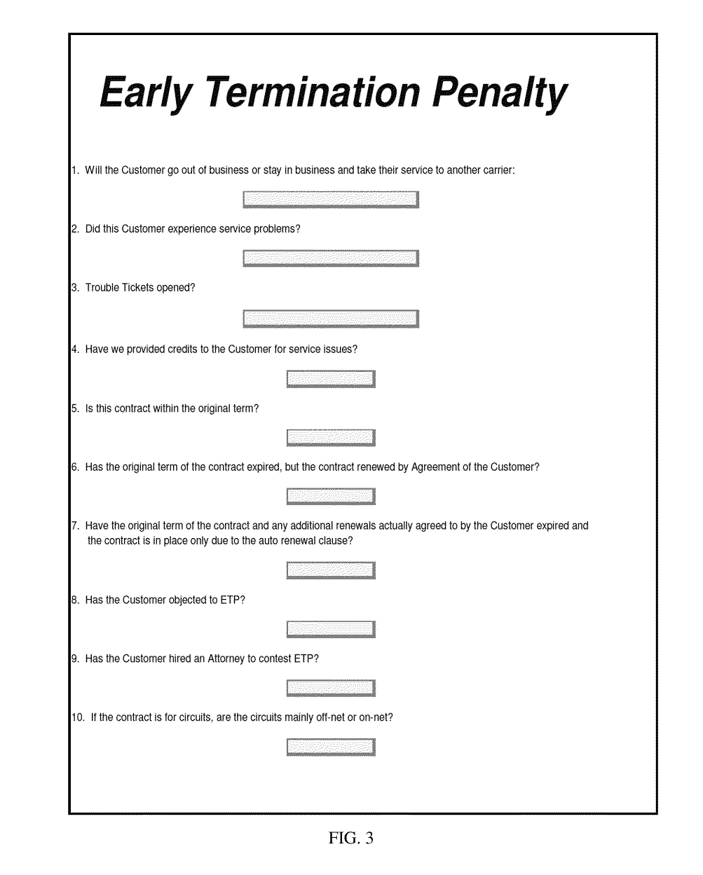

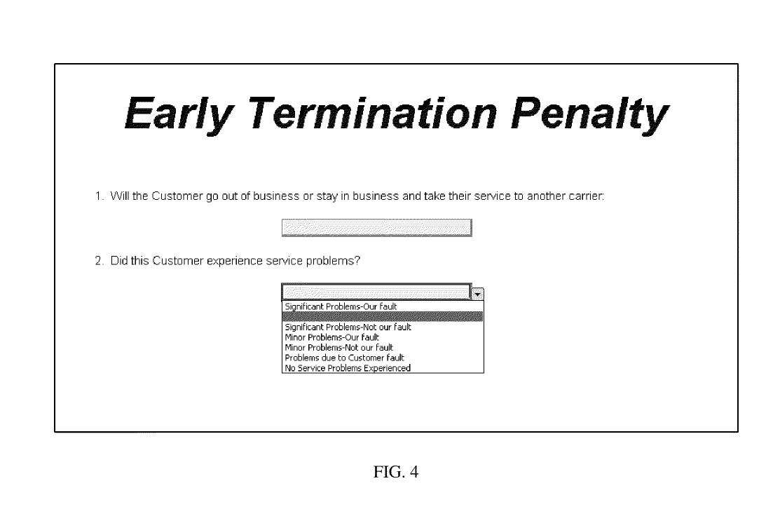

FIG. 3 is a representative screenshot of the assessment tool according to one embodiment of the invention. In this embodiment, a customer service representative answers question prompts using a standard computer. The answer field to each question contains a limited number of responses listed on a pull-down menu. Each question and answer field is presented to the user either sequentially or simultaneously on a computer screen or via other communicatory means, and the user can choose each answer using a standard mouse to open the pull-down menu and select one of the answers. FIG. 4 shows an example of a pull-down menu. In response to the possible question “Did this Customer experience service problems?,” the pull-down menu has the following choices: (i) no response; (ii) Significant Problems—Our fault; (iii) Significant Problems—Not our fault; (iv) Minor Problems—Our fault; (v) Minor Problems—Not our fault; (vi) Problems due to Customer fault; and (vii) No Service Problems Experienced. One skilled in the art will recognize that the list of possible answers can be longer, shorter, or comprise different answers depending on how the tool is programmed.

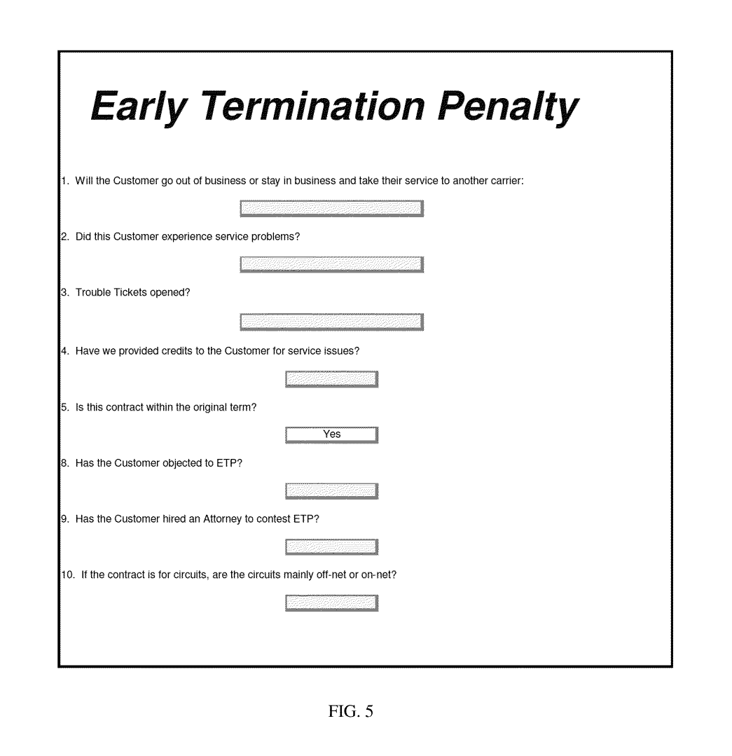

FIG. 5 is a representative screenshot of the assessment tool user interface. Here, the user interface is slightly different than the user interface shown in FIG. 3. For example, this user interface is missing questions #6 and #7. Since the user chose the response “Yes” to question #5 (“Is this contract within the original term”), the assessment tool eliminated the need to answer the next two questions because they did not apply. Thus, the user's answer selections can result in a difference in the order of the remaining questions, a difference in the weight of one or more questions, or a difference in the total number of remaining questions through either addition or elimination of questions, all depending upon how the tool is programmed.

In one embodiment, some of the required information is stored in a database such as a customer information database which optionally includes customer information. This information could include the time remaining in the service plan, the number of trouble tickets opened by the customer during the course of the service plan, any problems experienced by the customer and recorded by the telecommunications provider, information about service plan renewals, and other information regarding the history of the subscriber's account or interaction with the service provider. This information can be requested by the early termination program in response to one or more question prompts.

In a preferred embodiment, each question prompt from early termination penalty assessment program 10 can only be answered by a limited number of yes/no or short answers. This allows program 10 to perform downstream calculations with all answers and without requiring further interpretation of responses. For example, the range of possible answers to the question “is the subscriber going out of business?” could be limited to “yes,” “no,” and “unknown,” of which the representative must select one before being able to complete the assessment or move on to the next question prompt.

In step 18, early termination penalty assessment program 10 assigns a predetermined weight X to the answer for each question prompt. In the preferred embodiment, weight X is a numerical value determined by prior analysis, and the step is performed as the customer service representative answers each question. It will be recognized by one skilled in the art, however, that the assignment of weight X could be performed after all question prompts have been answered by the customer service representative. For example, in one embodiment the possible answers to the question “is the subscriber going out of business?,” which might be “yes,” “no,” and “unknown” and could be assigned the following weights: “if yes then X=0,” “if no then X=2000,” and “if unknown then X=1000.” As another example, the possible answers to the question “did the subscriber open trouble tickets or request troubleshooting assistance over the course of the service plan?” could be assigned weights such as “if 0 tickets then X=0,” “if 1 ticket then X=−500,” “if 2-4 tickets then X=−1000,” and “if 5 tickets then X=−1500.” It should be noted that these examples are only provided for explanatory purposes and are not intended to limit the program to these values or a similar range of values.

In step 20, early termination penalty assessment program 10 calculates a final assessment score based on the sum of the predetermined weights. In a preferred embodiment, the final assessment score is determined by a running calculation which is updated as the representative enters an answer to each question prompt. Accordingly, the final assessment score will be “0” or some other initial value when the representative initiates the program and will potentially increase or decrease as the representative answers each question and that answer's weight is added to the total. This preferred embodiment, of course, similarly requires that the assignment of a weight in step 18 be performed as the representative enters an answer to each question prompt.

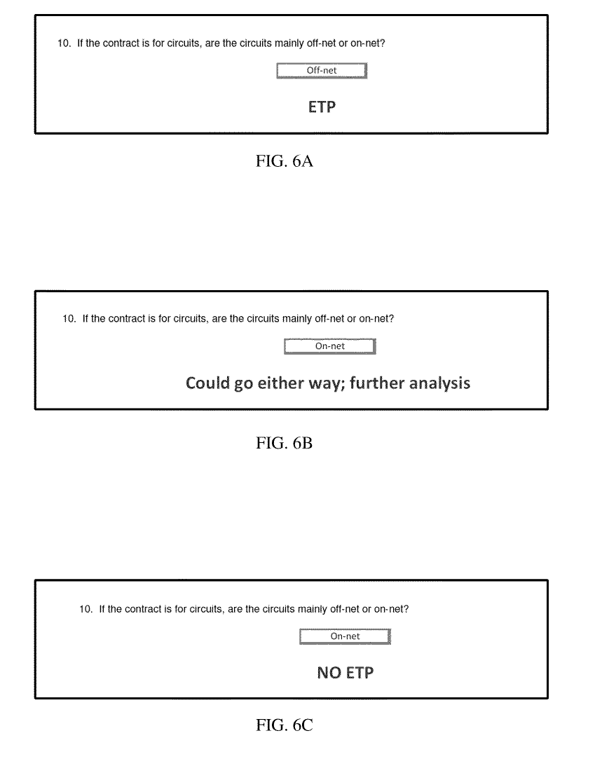

In step 22, early termination penalty assessment program 10 analyzes the final assessment score from step 20 to determine whether an early termination penalty should be levied on the subscriber. In a preferred embodiment, program 10 displays a message to the representative or otherwise provides the information to the user. For example, the program displays “Early Termination Penalty” or similar phrase if the final score is equal to or greater than a pre-determined benchmark score, and displays “NO Early Termination Penalty” or similar phrase if the final score is less than a pre-determined benchmark score. FIG. 6A shows the early termination penalty assessment program 10 displaying the representative message “ETP” after all or most questions have been answered, signifying to the user that based upon the tool's calculations an early termination penalty should be assessed. FIG. 6B shows program 10 displaying the representative message “Could go either way; further analysis” after all or most questions have been answered, signifying to the user that based upon the tool's calculations it is not clear whether an early termination penalty should be assessed. The further analysis suggested could include an additional set of questions, another assessment tool, or any other means of further analysis known to those in the art, including but not limited to a supervisory review. FIG. 6C shows program 10 displaying the representative message “NO ETP” after all or most questions have been answered, signifying to the user that based upon the tool's calculations that no early termination penalty should be assessed. It should be recognized that these final responses are provided only as examples, and thus the tool is not limited to either these responses or the limited number of responses shown. In one embodiment of the early termination penalty assessment program, the user interface returns the answer to the user as a percentage, ranking, or similar mechanism rather than as a simple “yes” or “no” answer.

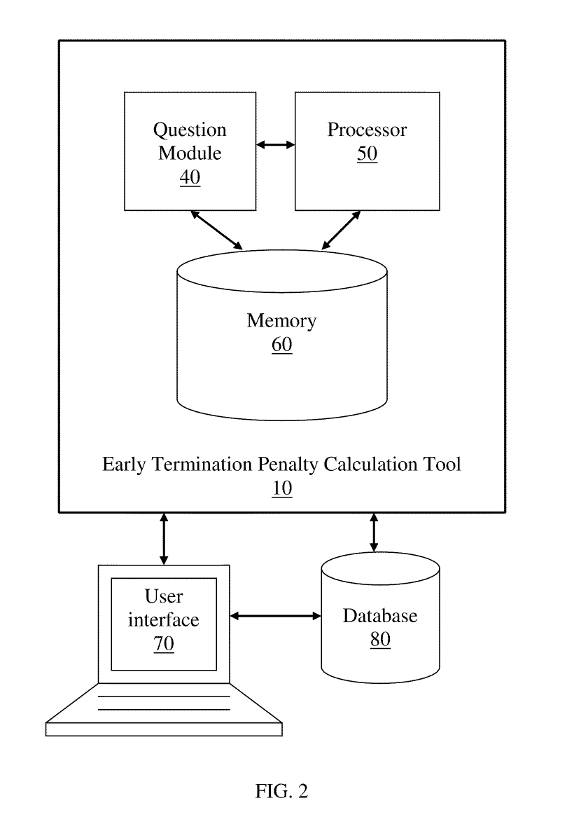

FIG. 2 is a high-level software schematic of early termination penalty assessment tool 10 according to one embodiment of the invention. The program includes a question module 40, which requests the question prompts and associated answer list from storage in permanent memory device 60 and communicates the question prompt and associated answer list to the user interface 70 such that the customer service representative can read the question and choose one of the provided answers. This function could be performed by the processor 50, which also assigns a predetermined weight, stored in memory device 60, to each answer from user interface 70, calculates the final score, and determines whether an early termination penalty should be levied. Upon this determination, processor 50 and/or question module 40 communicates the it to user interface 70. Memory device 60 could be any type of memory device known those skilled in the art.

In one embodiment, early termination penalty assessment tool 10 communicates with database 80. The database can optionally include information which will assist the program or the customer service representative answer one or more question prompts. For example, database 80 can optionally include customer information such as the time remaining in the service plan, trouble tickets opened by the customer during the course of the service plan, problems experienced by the customer and recorded by the telecommunications provider, and information about service plan renewals. Through the communication between the assessment program and the database the program can automatically provide answers to one or more question prompts, if the answer to that question can be determined from information within the database. In another embodiment, database 80 is directly accessible to the representative from user interface 70.

Although the present invention has been described in connection with a preferred embodiment, it should be understood that modifications, alterations, and additions can be made to the invention without departing from the scope of the invention as defined by the claims.

What is claimed is:

1. A method for recommending whether a telecommunications provider should levy an early termination penalty on a telecommunications service subscriber upon termination of the subscriber's service plan, the method comprising the steps:
receiving a request to terminate the subscriber's service plan;
providing at least a first question about the subscriber;
receiving a first answer to said at least first question;
assigning a first score to said first answer;
storing said first score in memory;
calculating a final score using said at least said first stored score; and
determining whether to levy an early termination penalty on said subscriber based on said final score.

2. The method of claim 1, wherein said request is from said subscriber.

3. The method of claim 1, wherein an early termination penalty assessment computer program assigns said first score to the at least one answer.

4. The method of claim 1, wherein said first answer is selected from a first list comprising at least a first possible answer to said at least one question and a second possible answer to said at least one question.

5. The method of claim 4, wherein said first answer is selected from said first list using a drop-down user interface element.

6. The method of claim 4, wherein each of said possible answers is associated with a predetermined score.

7. The method of claim 1, wherein said method is performed automatically upon receiving a request to terminate the subscriber's service plan.

8. The method of claim 1, wherein said method is performed upon receiving a request to terminate the subscriber's service plan only if said request is received before a contractual termination date of the subscriber's service plan.

9. The method of claim 1, further comprising the steps:
answering a second question about the subscriber;
assigning a second score to said second answer; and
storing said second score in memory.

10. The method of claim 9, wherein the answer to said first question determines whether said second question requires an answer.

11. The method of claim 9, further comprising the steps:
assigning a first weight to said first score; and
assigning a second weight to said second score.

12. The method of claim 11, wherein the step of storing said first score in memory comprises storing said first weighted score in memory, and further comprising the step:
storing said second weighted score in memory.

13. The method of claim 12, wherein the step of calculating said final score comprises calculating the final score using at least said first and second weighted scores.

14. The method of claim 1, further comprising the step:
notifying a user whether to levy an early termination penalty.

15. The method of claim 1, further comprising the step:
sending said request to a customer service representative.

16. The method of claim 15, further comprising the step:
notifying said customer service representative of said determination.

17. An early termination penalty assessment tool comprising:
a memory storage device, wherein said memory storage device stores at least a first question and at least a first and second possible answer to said first question;
a user interface, wherein said user interface displays said at least a first question and at least a first and second possible answer to said first question to a user, and further wherein said user interface receives input selecting one of said at least a first and second possible answer; and
a processor, wherein said processor assigns a first score to said selected answer, and further wherein said processor calculates a final score based on at least said first score and determines whether to assess an early termination penalty based on the calculated final score.

18. The early termination penalty assessment tool of claim 17, wherein said memory storage device stores a predetermined score for each of said first and second possible answers.

19. The early termination penalty assessment tool of claim 17, wherein said memory storage device stores said first score.

20. The early termination penalty assessment tool of claim 17, further comprising:
a customer information database, wherein said input is based on information from said customer information database.
